(19) United States
(12) Patent Application Publication
(10) Pub. No.: US 2026/0255186 A1
(43) Pub. Date: Aug. 27, 2026

(54) ACTIVATION OF A BACKUP USER TERMINAL TO TRANSMIT DATA TO ENSURE QOS

(71) Applicant: TELEFONAKTIEBOLAGET LM ERICSSON (PUBL), Stockholm (SE)

(72) Inventors: Paul SCHLIWA-BERTLING, LJUNGSBRO (SE); Massimo CONDOLUCI, Solna (SE)

(21) Appl. No.: 18/874,890

(22) PCT Filed: Jun. 20, 2020
(86) PCT No.: PCT/SE2022/050605

§ 371 Date: Dec. 13, 2024

(51) Int. Cl. H04W 24/04; H04L 41/0668; H04L 69/28

(52) U.S. Cl. CPC H04W 24/04; H04L 41/0668; H04L 69/28

(57) ABSTRACT

A method (1100) by a User Equipment, UE, operating as a backup UE (105, 205) for at least one main UE 202 for data communication includes receiving (1102), from a network node (110, 210), information indicating a status of a backup mode of the UE as active. Based on the status of the backup mode of the UE being active, the UE processes (1104) data received from an upper layer without delivering the data to a lower layer. If the status of the backup mode changes from active to inactive before an expiration of a timer associated with the backup mode of the UE, the UE delivers (1106) the data to the lower layer. However, if the status of the backup mode does not change from active to inactive before the expiration of the timer associated with the backup mode of the UE, the UE discards (1108) the data.

### TECHNICAL FIELD

The present disclosure relates, in general, to wireless communications and, more particularly, systems and methods for backup user equipment mode.

### BACKGROUND

Several use cases are being discussed in Third Generation Partnership Project (3GPP) Technical Specification Group Service and System Aspects (TSG SA) WG1 (SA1) such as, for example, for smart factory backup in a multi-modality Interaction System. See, S1-212071, TACMM New Use Case Smart-Factory backup in Multi-modality Interaction System, Jun. 29, 2021. An example of a multi-modality system in a smart factory could be a group of sensors that report monitoring data to a controller. In particular, each device may have an application running on top. Inputs may be generated by these different devices, which may include user equipments (UEs). The controller then evaluates the monitoring data received from all the sensors and generates instructions for motion control of the devices. In this scenario, skipping a single sensor from data aggregation may affect the accuracy of motion control or even lead to a production line breakdown. For such case, service robustness is very important.

FIG. 1 illustrates an example of a backup for multi-modality interaction system that includes both backup input devices and main input devices. Specifically, the backup input devices are used to provide backup input in case input from the main input devices are not received. An application server (AS) hosts the controller and needs to receive inputs from the devices to make a decision. In the example of FIG. 1, UE1 and UE3 are the main sources of input. As the system needs robustness with regard to the input provided to the controller, UE2 and UE4 operate to provide backup input to the controller in case the inputs from UE1 or UE3 are not received by the controller. For example, if UE1 experiences radio link failure or handover to another cell and the input of UE1 does not reach the controller, UE2, as the backup UE, should be triggered to take over UE1's task to achieve better service robustness for multi-modality. For example, the 5G network may detect the handover or radio link failure of UE1 and trigger UE2 to take over UE1's task to achieve better service robustness for multi-modality.

Additionally, in 3GPP TS 23.501, § 5.33.2.1 V. 17.4.0, features have been introduced for Redundant User Plane Paths based on dual-connectivity. The features support highly reliable Ultra-Reliable Low Latency Communications (URLLC) services. Specifically, a UE duplicates user plane packets and sends the duplicate packets over different paths. For example, the UE may set up two redundant but disjointed Packet Data Unit (PDU) Sessions over the 5th Generation (5G) network. The UE may then perform packet duplication and send the packets over the two paths. Alternatively, the UE may switch between the two paths based on path availability. In this case, the focus is on one application (e.g., an application client), which leverages having one UE with multiple disjointed paths through the 5G system via dual connectivity, for example, or even multiple paths via 5G and non-3GPP links. Upper layer protocols such as IEEE 802.1 Time Sensitive Networking (TSN) Frame Replication and Elimination for Reliability (FRER) are used to manage the duplication and elimination of redundant packets/frames over the duplicate paths. U.S. Patent Publication No. 2020/0351969A1 and U.S. Patent Publication No. 2021/0367703A1provide examples solutions where dual connectivity (DC) is used for user plane redundancy over radio and where disjointed Session Management Functions (SMFs) are used to setup PDU Sessions towards disjointed User Plane Functions (UPFs). Nevertheless, the scenario targeted by these solutions is different from the scenario shown in FIG. 1 where the main and backup devices are actually two separate devices, so solutions such as Redundant User Plane Paths based on DC cannot be used among these two devices (as in the scenario in FIG. 1since two different applications use two different UEs).

3GPP TS 23.501, Annex F, describes an approach to realize multiple user plane paths in the system based on one device having multiple UEs and specific network deployments. This approach assumes a Radio Access Network (RAN) deployment where redundant coverage by multiple gNodeBs (gNBs) (in the case of NR) is generally available. Upper layer protocols, such as IEEE 802.1 TSN, can make use of the multiple user plane paths. Although this scenario could be considered closed to the scenario in FIG. 1 as the terminal device integrates multiple UEs which can connect to different gNBs independently, the key difference is that, in this scenario, there is one device having multiple UEs. Thus, the device has a direct relationship with different UEs and consequently can choose which UE(s) to use for data connectivity among the available ones. By contrast, in FIG. 1, there are different devices each associated to one UE.

Previous techniques focus on how to enable a single UE to have multiple paths (and on how to handle these multiple paths) and on how a device can handle connectivity through multiple UEs associated to it. Approaches for scenarios like in FIG. 1 with independent devices, each with its own UE, are based on application-level design, hereby referred to as over-the-top (OTT) solutions. Some possible OTT approaches could be grouped in the following groups (assuming UE1 relates to the main input and UE2 to the backup input):
OTT approach based on data duplication: Both UE1 and UE2 could send their data to the AS. If both transmissions are successful, the server will discard inputs from UE2. However, if the transmission from UE1 fails, the inputs from UE2 will already be available at the server. In this case, the higher the number of input devices/UEs that send inputs to the controller, the lower the probability that at least one input will be successfully delivered.
OTT approach based on input status: AS monitors data reception from UE1 (or, overall, availability for data transfer of UE1) and triggers data transfer from/to UE2 if UE1 is not available. This approach is useful to reduce the issues with data duplication. For instance, in case of periodic transfer, the server could monitor whether data from UE1 has failed to arrive in the expected time slot and consequently trigger UE2 if needed. Or, in case of continuous transmission from UE1, for example (e.g., camera video flow), the server could monitor whether such transmission is interrupted or degrades below a certain threshold and consequently trigger UE2 if needed. Another variant of this approach is based on usage of network notifications. For instance, the service could rely on an Application Function (AF) to subscribe for a certain UE (main UE) to network event notifications (monitored e.g., by Access and Mobility Management Function (AMF)/Session Management Function (SMF) such as loss of connectivity, communication failure, etc.) and/to network analytics (generated by Network Data Analytics Function (NWDAF) such as Quality of Service (QOS) Sustainability Analytics, etc.) exposed through the exposure framework (e.g., Network Exposure Function (NEF)).

There currently exist certain challenge(s). Current solutions cover scenarios where service robustness is provided either via (i) one device having one UE with capabilities to connect to multiple Radio Access Technologies (RATs) (e.g., dual-connectivity, 3GPP/non-3GPP access) or (ii) one device having multiple UEs connected to different cells of the same RAT or to different RATs. For scenarios like those investigated in 3GPP SA1 and showed in FIG. 1, where one device has one UE, service robustness among different devices/UEs can be provided via OTT solutions. Such solutions have drawbacks.

For example, one problem associated with the OTT approach based on data duplication is that more traffic is put into the network, which could consequently create congestion, which may limit the overall cell capacity and cause performance limitations to other users. Additionally, the OTT approach based on data duplication may result in unnecessary double traffic charging if the main input is always successfully received. Furthermore, as an increase in service robustness is related to enhancing data duplication by increasing the number of devices/UEs, higher service robustness may bring higher data traffic into the network. Similar problems are common also to solutions based on data duplication applied to two redundant PDU Sessions or to multiple user plane paths.

Another problem occurs because, even if there are multiple possible backup UEs, the AS might not have information as to whether a certain backup UE is a good choice or not. For instance, the UE could be in a poor coverage situation or in a congestion situation. This may not be known unless the UE is transmitting to the server. Further, there would be even higher delays if, for example, one backup UE cannot be triggered in a timely manner and another UE should be triggered instead. If the service is using solutions based on exposure of network notifications, one has to consider the following sources of delay: detection by Network Functions (NFs) of event (e.g., loss of connectivity, communication failure by e.g., AMF/SMF) or generation by NWDAF of analytics (e.g., QoS Sustainability Analytics), exposure through the exposure framework (e.g., AMF/SMF/NWDAF->NEF->AF), interaction AF—server so that the AS is informed that the main UE is not (or has not being) able to transmit, and finally the server can trigger the backup UE.

Accordingly, current approaches based on OTT solutions for backup for multi-modality interaction systems suffer either (i) in terms of higher data traffic due to packet duplication from multiple UEs or (ii) in terms of delay for obtaining desired inputs from backup UEs. Furthermore, the delay for obtaining inputs from the backup UE is also influenced by the lack of knowledge as to whether a certain target UE is a good candidate as a backup UE since the AS lacks network knowledge as to, for example, whether the target UE is in good coverage.

### SUMMARY

Certain aspects of the disclosure and their embodiments may provide solutions to these or other challenges. For example, methods and systems are provided for introducing a backup mode for operation of UEs. The backup mode is enabled and/or disabled by the mobile network based on information received from an application. If the backup mode is active, the UE processes data packets that are received from upper-layers and then stores the processed data packets for a certain amount of time without delivering them to lower layers. The UE then discards the packets at some point if the backup mode remains in an active state. However, if the backup mode is transitioned to inactive within a period of time, then the UE performs data transmissions of the stored data packets.

According to certain embodiments, a method by a UE operating as a backup UE for at least one main UE for data communication includes receiving, from a network node, information indicating a status of a backup mode of the UE as active. Based on the status of the backup mode of the UE being active, the UE processes data received from an upper layer without delivering the data to a lower layer. If the status of the backup mode changes from active to inactive before an expiration of a timer associated with the backup mode of the UE, the UE delivers the data to the lower layer. If the status of the backup mode does not change from active to inactive before the expiration of the timer associated with the backup mode of the UE, the UE discards the data.

According to certain embodiments, a UE operating as a backup UE for at least one main UE for data communication is adapted to receive, from a network node, information indicating a status of a backup mode of the UE as active. Based on the status of the backup mode of the UE being active, the UE is adapted to process data received from an upper layer without delivering the data to a lower layer. If the status of the backup mode changes from active to inactive before an expiration of a timer associated with the backup mode of the UE, the UE is adapted to deliver the data to the lower layer. If the status of the backup mode does not change from active to inactive before the expiration of the timer associated with the backup mode of the UE, the UE is adapted to discard the data.

According to certain embodiments, a method by a network node includes configuring a UE operating as a backup UE for a main UE to, based on a status of a backup mode of the UE as being active, process data received from an upper layer of the UE without delivering the data to a lower layer. If the status of the backup mode changes from active to inactive before an expiration of a timer associated with the backup mode of the UE, the UE is configured to deliver the data to the lower layer. If the status of the backup mode does not change from active to inactive before the expiration of the timer associated with the backup mode of the UE, the UE is configured to discard the data. The network node transmits, to the UE, information indicating the status of the backup mode of the UE as active.

According to certain embodiments, a network node is adapted to configure a UE operating as a backup UE for a main UE to, based on a status of a backup mode of the UE as being active, process data received from an upper layer of the UE without delivering the data to a lower layer. If the status of the backup mode changes from active to inactive before an expiration of a timer associated with the backup mode of the UE, the UE is configured to deliver the data to the lower layer. If the status of the backup mode does not change from active to inactive before the expiration of the timer associated with the backup mode of the UE, the UE is configured to discard the data. The network node is adapted to transmit, to the UE, information indicating the status of the backup mode of the UE as active.

According to certain embodiments, a method by an AF or AS includes transmitting information indicating that a UE is operating as a backup UE for a main UE. The AF or AS transmits, to the network node, at least one condition for transitioning a status of a backup mode of the UE from active to inactive or inactive to active. When the status of the backup mode of the UE is active, the UE processes data from an upper layer without delivering the data to a lower layer. When the status of the backup mode of the UE is inactive, the UE delivers the data to the lower layer.

According to certain embodiments, an AF or AS is adapted to transmit information indicating that a UE is operating as a backup UE for a main UE. The AF or AS is adapted to transmit, to the network node, at least one condition for transitioning a status of a backup mode of the UE from active to inactive or inactive to active. When the status of the backup mode of the UE is active, the UE processes data from an upper layer without delivering the data to a lower layer. When the status of the backup mode of the UE is inactive, the UE delivers the data to the lower layer.

A method by UE operating as a main UE for data communication receiving, from a network node, a first information indicating a first status of a backup mode of the UE as inactive. Based on the first status of the backup mode of the UE being inactive, the UE processes first data received from an upper layer of the UE and delivers the first data to a lower layer of the UE. The UE receives, from the network node, a second information indicating a second status of the backup mode of the UE as active. Based on the second status of the backup mode of the UE being changed to active, the UE processes second data from the upper layer of the UE without delivering the second data to the lower layer of the UE.

A UE operating as a main UE for data communication is adapted to receive, from a network node, a first information indicating a first status of a backup mode of the UE as inactive. Based on the first status of the backup mode of the UE being inactive, the UE is adapted to process first data received from an upper layer of the UE and delivers the first data to a lower layer of the UE. The UE is adapted to receive, from the network node, a second information indicating a second status of the backup mode of the UE as active. Based on the second status of the backup mode of the UE being changed to active, the UE is adapted to process second data from the upper layer of the UE without delivering the second data to the lower layer of the UE.

Certain embodiments may provide one or more of the following technical advantage(s). For example, as compared to previous OTT approaches based on data duplication, certain embodiments disclosed herein may provide a technical advantage of reducing network traffic since data duplication from main and backup UEs is not necessary to achieve high reliability. As such, system capacity may be improved.

As a further example, a problem with the OTT approach based on input status is the delayed activation of UE2 since it is constrained to the AS reacting to missing inputs from UE1. This delayed activation is influenced by two components: (i) delay in determining missing inputs from UE1 and (ii) delay in triggering UE2. For instance, even in case of a periodic or deterministic transmission from UE1 (i.e., the server knows a-priori when data from UE1 should be received), if radio transmission from UE1 fails, the AS may notice this only after a delay, D, that is equal to the transport+core+Internet delay (as this would be the delay with which the application would have received data from UE1). As such, although UE1 fails to transmit data at time X, the AS will know not know about this failure until time X+D and only then will the AS be able to start the process for triggering UE2 to begin transmissions. Then, the trigger of UE2 will happen via application-layer signalling, which is constrained by the whole user plane delay. This user plane delay includes a first full user plane delay when the server contacts UE2, a second full user plane delay when the UE2 sends its data, and a third user plane delay to, for instance, switch to CONNECTED mode, if needed, to request a grant, etc. Thus, the delay for receiving inputs from UE2, when X is the moment when UE1 fails its radio transmission, is equal to: D+one full user plane delay+delay for UE2 to have radio resources for transmission+one full user plane delay. In case the server is not a-priori aware of the expected traffic from the main UE(s), then the server should implement some policies to understand if triggering of backup UE would be needed. For example, these policies may be based on a timer from last transmission from the main UE. As another example, these policies may be based on bitrate threshold from the main UE. Overall, this could add extra delay in understanding whether backup UE should be enabled.

However, as compared to these previous OTT approaches based on input status, certain embodiments disclosed herein may provide a technical advantage of lowering the time of delay associated with the activation of the backup UE. For example, where UE1 is the main UE and UE2 is the backup UE, if UE1 fails to transmit its data at time X, the network node knows directly at time X that data transfer from UE2 should be enabled and can directly start the signalling to activate the backup UE. Compared to previous OTT approaches, the network node is not limited by a-priori traffic knowledge to understand if UE1 failed to transmit data since the network node has visibility of the actual traffic and tentative from UE1 to transmit data, reflected for instance by random access tentative, failures with HARQ/ARQ, failures with grant assignments, etc. As a result, detection of UE1 not being able to transmit data from network-side has higher potential to be more accurate and quicker, without constraints such as a-priori traffic knowledge for efficient detection of missing inputs from main UE. Furthermore, being the signalling to activate data transfer from backup UE is only related to the radio interface, the delay is expected to be lower than the delay for activating UE2 via the previous OTT approaches that included multiple instances of user plane delay. Additionally, the network node may have mechanisms to prioritize such signalling. Specifically, as compared to the case of services based on network exposure, this delay may be lower than the delay resulting from NFs generating the relevant information, exposing them to the AF/AS, plus the final one full user plane delay for the server to contact the UE2.

As still another example, certain embodiments disclosed herein may provide a technical advantage of enabling the backup UE to process and store the incoming application data in the radio access stack until, for example, the backup timer expires. This could help to reduce delay due to signalling by enabling data transfer from the backup UE. Consequently, the AS is able to receive also some or all of the information generated prior to the enabling of data transfer from the backup UE. As such, certain embodiments may reduce loss of information at server side. Additionally, enabling tuning of how long data is kept by the backup UE before it is discarded allows for the provision of different levels of service robustness and information loss at the server.

As yet another example, certain embodiments disclosed herein may provide a technical advantage of enabling the network, which has richer information of UE radio conditions, to choose a backup UE in a wiser way as compared to previous OTT approaches. As such, certain embodiments may result in higher service robustness (in addition to lower delay compared to AS trying different backup UEs until a reliable one is found).

As still another example, since the mobile network has better visibility of the status of UEs and is able to monitor parameters related to both user-plane and UE status, the network node is able to setup transmission from backup UEs in a more reliable way as compared to previous OTT approaches. For instance, if UE1, as a main UE, is performing an handover or might be suffering from temporary poor radio conditions and consequently data transmissions are affected by delay, the AS may not understand that UE1 has data to be transmitted but is not able to do so. As a consequence, the AS cannot trigger the UE2 as backup. However, the mobile network has visibility that UE1 has data to be transmitted and, consequently, can trigger the transmission from UE2. Furthermore, mobile network could use historical, analytical, and/or predictive data for proactive activation and/or deactivation of data transfer from backup UE(s). As a result, certain embodiments increase robustness and reliability for end-services. Compared to previous approaches based on upper-layers (e.g., multi-path transport protocols, redundant user plane paths based on multiple UEs per device, IEEE 802.1 TSN), a technical advantage of certain embodiments is that main/backup UEs shouldn't always have active user plane to increase reliability or to cut activation time of backup UE, as the mobile network could detect the need to activate the data transfer from backup UE earlier (and, potentially, proactively) than the upper-layers of the end-service. Thus, a same level of service reliability may be reached with less traffic within the network.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of a backup for multi-modality interaction system that includes both backup input devices and main input devices;

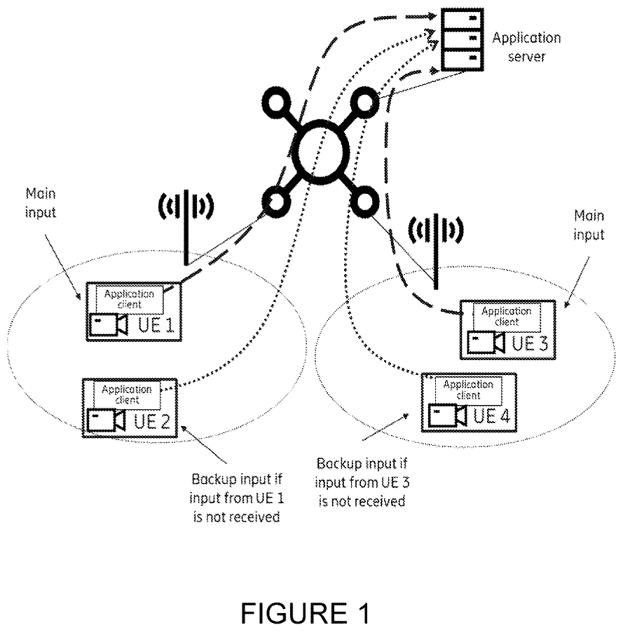

FIG. 2 illustrates a signaling diagram 100 for a configuration of backup mode for a backup UE, according to certain embodiments;

FIG. 3 illustrates a high-level signalling diagram of the mobile network for enabling and/or disabling data transfer for a backup UE, according to certain embodiments;

FIG. 4 illustrates a flowchart of network side operations for the activation and/or deactivation of backup mode status, according to certain embodiments;

FIG. 5 illustrates an example flow diagram representing the operations of a UE in backup mode, according to certain embodiments;

FIG. 6 illustrates an example communication system, according to certain embodiments;

FIG. 7 illustrates an example UE, according to certain embodiments;

FIG. 8 illustrates an example network node, according to certain embodiments;

FIG. 9 illustrates a block diagram of a host, according to certain embodiments;

FIG. 10 illustrates a virtualization environment in which functions implemented by some embodiments may be virtualized, according to certain embodiments;

FIG. 11 illustrates a host communicating via a network node with a UE over a partially wireless connection, according to certain embodiments;

FIG. 12 illustrates a method by a UE operating as a backup UE for at least one main UE for data communication, according to certain embodiments

FIG. 13 illustrates a method by a network node, according to certain embodiments;

FIG. 14 illustrates a method by an AF or AS, according to certain embodiments; and

FIG. 15 illustrates a method by a UE operating as a main UE for data communication, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

As used herein, the terms Application Function (AF) and application server (AS) are used to indicate the application layer which interacts with the mobile network and which transfer data with the applications at UE side. The AF and the AS are two logically separated entities, with the AF being in charge of interacting with the NFs of the mobile network (Network Exposure Function (NEF), Policy Control Function (PCF), etc.), with the AS exchanging data packets with the application clients at UE side, and with the AF and the AS interacting among each other to exchange relevant information. In practice, they could also be separated from an implementation or deployment point of view.

As used herein, main UE refers to a UE that is indicated by the AF and/or AS as the default UE for a certain data communication. By contrast, as used herein, the term Backup UE refers to a UE that is indicated by the AF and/or AS as the UE which should provide data when data from the main UE is not available.

According to certain embodiments, a “backup mode” status is introduced in a mobile terminal. The backup mode drives the behavior of the terminal with regards to delivering information processed for data transmission to lower layers for the effective transmission over the radio channel. The backup mode status is handled by the mobile network, according to some embodiments. For example, the mobile network uses information received from an application layer about the relationships between main UE(s) and backup UE(s). The mobile network disables data transmission (by setting the backup mode status to active) from a backup UE if the associated main UE is in a situation where it can successfully transmit data. In this case, the backup UE processes the data received from upper layers; however, these data packets are not delivered to lower layer(s) for radio transmission by the backup UE unless the backup mode is inactivated by the network within a certain time from data reception. In a particular embodiment, the mobile network monitors the capability of data transferring of the main UE, and if the mobile network determines that the main UE cannot transfer data in a certain moment or within a certain time frame, the mobile network enables data transmission from the backup UE by setting the backup mode status of the backup UE to inactive.

According to certain embodiments, a method may include one or more of the following:
The mobile network receives information from an application indicating which UE(s) should be set as backup UE(s) for a certain UE, and the network uses such information to set the backup mode for the indicated UEs and to set relevant monitoring features for the involved UEs. This can be seen as a setup phase and is discussed in more detail below.
The mobile network monitors the capability of successful data transfer for involved UEs and, if necessary, updates the backup mode status of one or more backup UEs. The enabling/disabling of data transmission for backup UEs is discussed in more detail below.
As used herein, a backup mode status of active means that a UE doesn't deliver data packets, which may include Session Data Units (SDUs), that are ready for data transmission directly to lower layers unless the backup status of the UE is changed by the network. In a particular embodiment, for example, a backup mode timer is used and is described in more detail below. The activation of backup mode could also involve changes to settings of other parameters at the UE side, as well as interactions with the application layer at the UE side to indicate whether backup mode has been activated or inactivated. The operations of a backup UE are also described in more detail below.

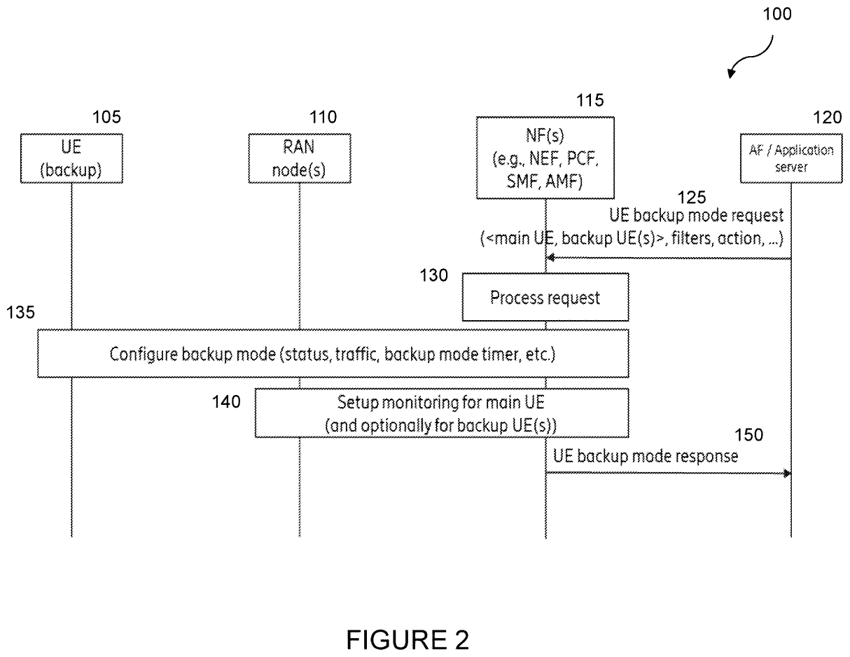

FIG. 2 illustrates a signaling diagram 100 for a configuration of backup mode for a backup UE, according to certain embodiments. Specifically, FIG. 2 illustrates example signaling between a backup UE 105, RAN node 110, NF 115, and AF/AS 120. As illustrated, at step 125, the AF/AS 120 interacts with the mobile network (e.g., NFs) to provide information about which UEs/flows are involved in the setting of the backup mode. For example, as shown, the AF/AS 120 interacts with a NEF, PCF, SMF, or AMF 115. This interaction can be a request-response interaction performed using a newly introduced operation service. The AF 120 provides information to the mobile network, including (but not limited to):
Information about main UE/flows. This could be in the form of UE identities such as, for example, Internet Protocol (IP) addresses, Generic Public Subscription Identifiers (GPSIs), Subscription Permanent Identifiers (SUPIs), etc. Optionally, this can be complemented with information about which specific traffic of the main UE requires a backup, e.g., by indicating that backup is required for specific traffic relevant to certain QoS parameters (e.g., requested/minimum/maximum bitrate, maximum latency, maximum packet losses, etc.) or for a traffic identified by certain mapping rules such as 5-tuple, appID, etc. According to a particular embodiment, a backup UE 105 is enabled for data transmission only if the main UE is not capable of transferring that particular type of traffic (eventually in accordance with some QoS requirements if relevant).
Information about backup UE(s). This could be in the form of UE identities such as, for example, IP addresses, GPSIs, SUPIs, etc. Optionally, this can be complemented with information about which specific traffic the backup is required for such as, for example, traffic relevant to certain QoS parameters, 5-tuple, appID, etc. In a particular embodiment, for example, the backup mode applies only to that specific traffic. In case of multiple backup UEs, the backup UEs 105 are listed in a prioritized order, in a particular embodiment.
Filter information indicating when, i.e. under what conditions, the backup UE(s) should be enabled for data transmission. According to certain embodiments, this field allows the network to understand how to handle the enabling/disabling of data transmission for backup UE 105 with respect to the associated main UE. Examples of filter information are (but are not limited to):
   Data failed to be transmitted. In a particular embodiment, the application indicates that data transmission from backup UE 105 should be enabled only if the main UE has tried to send data but it has failed.
   Radio issues. In a particular embodiment, the application indicates that data transmission from backup UE 105 should be enabled in any case when the main UE has poor radio conditions such as, for example, if the channel quality goes below a certain threshold if the main UE is performing an handover and so on.
   QoS unfulfillment. In a particular embodiment, the application indicates that data transmission from backup UE 105 is enabled only if the main UE is not currently fulfilling its QoS targets.
   Time before data transfer from backup UE. This indicates that the application wants that data transfer from backup UE 105 if the main UE fails to transfer data for a certain amount of time. This field could be in the form of a value in ms, e.g., Xms, associated to another filter, and in this case, the network will enable data transfer from a backup UE 105 if the main UE has failed to transfer data (or has been in poor radio conditions, or its QoS has been unfulfilled) for an amount of time longer than Xms.
Information about which actions the application wants. In a particular embodiment, this field is used to indicate whether the application is interacting with the mobile network to update (e.g., change backup UEs) or revoke a previously requested backup mode operation. It could be complemented with e.g. an ID of a previous request.

In step 130, the mobile network (e.g., NFs 115) processes the information received from the AF/AS 120. The processing might involve interactions among several NFs, e.g., between a NEF and a PCF and a Unified Data Management (UDM), AMF, SMF, etc. The process might include, for instance, checking whether the application is authorized to request the backup mode operation, checking whether the UE(s) listed as backup UE 105 satisfies the capability of supporting backup mode operations, translating information about traffic to apply the backup mode (e.g., 5-tuple) to identifiers such as 5G Quality of Service Identifier (5QI)/QOS Flow Identifier (QFI), etc.

In step 135, the mobile network configures the backup mode towards the involved UEs. This could be done by involving several NFs (PCF, SMF, AMF, etc.) 115 and RAN nodes 110 of the mobile network. The configuration towards the UEs could be done e.g., by Non-Access Stratum or/and access-stratum (e.g., Radio Resource Control (RRC)) signalling, in various particular embodiments. The configuration is received by the target UEs and then applied. In particular embodiments, the configuration includes (but is not limited to):
Status of the backup mode (either active or inactive). The status is set to active if the UE should behave in backup mode (i.e., not proceed with data transmission over the radio channel)
Backup mode traffic. Information indicating for which traffic the backup mode is requested, e.g., a 5QI, QFI, etc. If this field is not present, the backup mode applies to all traffic of the UE.
Backup mode timer. A value in e.g. ms, or an indication to a value in ms (starting e.g. from Oms to Xms).
Additional configuration of RAN stack to be applied when backup mode is active. This could be optional and could include specific settings of RAN stacks (timers, thresholds, etc.) that should be applied when backup mode is active. Examples are, changes of timers to switch from CONNECTED to IDLE mode (and/or from active to inactive), changes of thresholds of e.g. Reference Signal Received Power (RSRP)/Reference Signal Received Quality (RSRQ) values related to mobility, etc.

The UE(s) configured as backup UE 105 could inform the application at UE side that backup mode has been activated. This could be done by using, for example, APIs between the radio modem/chipset and the operating system and APIs between the operating system and the application layer.

In particular embodiments, the radio stack layer where backup mode timer applies could be either a value configured by the network or left to UE implementation or left to standardization. Given that the user plane traffic should be processed to understand whether the backup mode applies to the traffic or not, layers such as Service Data Adaption Protocol (SDAP) or Packet Data Convergence Protocol (PDCP) are good candidates for performing the processing as these layers can understand, for example, to which 5QI the traffic belongs to and consequently apply the backup mode operations. Where it is described that these layers process the received data without delivering the data packets to lower layers, it is recognized that various different types of processing may be included in the processing step. For example, if backup UE mode processing is performed by the SDAP, the processing step may simply involve checking whether backup mode operation applies to incoming packets and, if so, keeping them in a “backup mode buffer” without performing any additional processing at SDAP. As another example, if the backup UE 105 processing is performed by the PDCP, the processing step may simply involve checking whether backup mode operation applies to certain radio bearers and putting packets associated to these into a “backup mode buffer” without any further processing (e.g., processing such as encryption could be applied by PDCP only if backup mode is disabled).

At step 140, the mobile network configures the relevant monitoring tasks associated to the main UE. For instance, the mobile network may configure the main UE to monitor whether data transmissions from main UE fail, or if the main UE suffers from poor channel condition, or if the QoS goals of the main UE are unfulfilled, and eventually monitoring of data transmission capabilities from backup UE(s). More examples on possible monitoring tasks that may be performed by a main UE are described below.

At step 145, the mobile network provides a response to the AF and/or AS 120, which indicates whether the request of backup mode for the involved UEs has been successfully accepted (eventually with an ID to be used as reference for future interactions with the application), or whether the request of the backup mode for the involved UEs has failed or was refused.

### Enabling/Disabling Data Transfer for a Backup UE

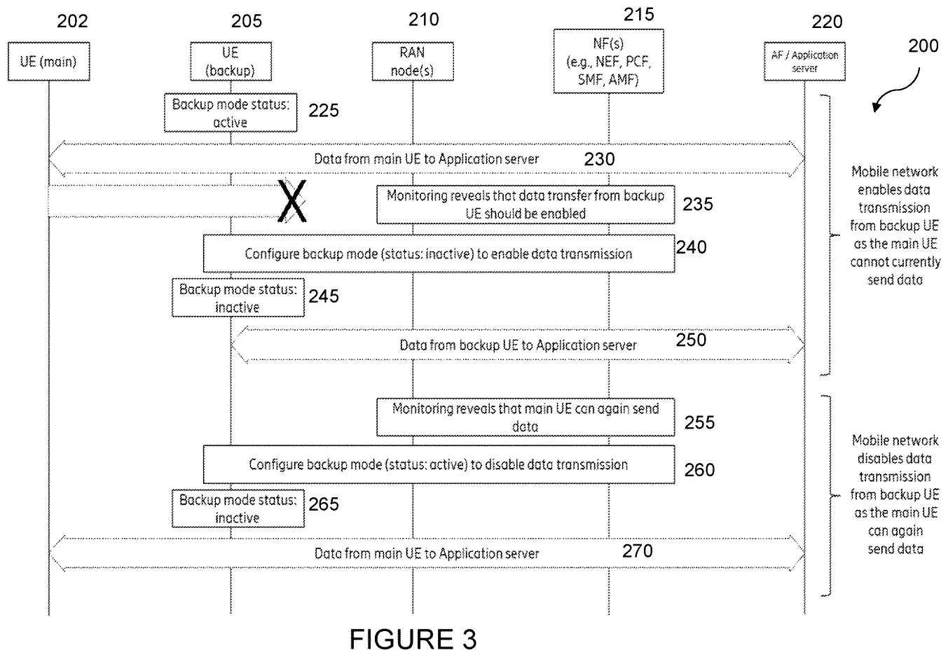

FIG. 3 illustrates a high-level signalling diagram 200 of the mobile network for enabling and/or disabling data transfer for a backup UE, according to certain embodiments. Specifically, FIG. 3 illustrates example signaling between a main UE 202, a backup UE 205, RAN node 210, NF 215, and AF/AS 220.

Initially, the backup mode status of the backup UE 205 is set to active, at step 225. As such, the main UE 202 is transmitting data at step 230, and there is no data transfer from the backup UE 205.

At step 235, the mobile network (e.g., RAN nodes 210 and/or 215) monitors whether conditions for enabling data transmission from backup UE 205 are met. Several options are possible depending on the type of backup the application has requested (the “Filters” field in the application request), and/or depending on network implementation and policies. As used herein, the term monitoring refers to both monitoring of actual conditions and to analytics/predictions (e.g., prediction that main UE will not be able to send data). It could be, for instance, that the main UE 202 is successfully transmitting a scheduling request to a base station, but the base station predicts that the data transmission from the main UE 202 will not be successful and decides, thus, to enable data transfer from the backup UE 205. Examples are, but not limited to:
Data failed to be transmitted. In a particular embodiment, the mobile network (e.g., RAN nodes 210 and/or 215) monitors, for example, whether data reception from main UE 202 is failing by looking at e.g., number of failed Hybrid Automatic Repeat Request (HARQ) re-transmissions, number of failed Automatic Repeat Request (ARQ) re-transmissions. Additionally or alternatively, the monitoring may include, for example, determining the number of occurrences when the main UE 202 has sent a scheduling request (SR) or a buffer status report (BSR) but no consequent grant has been assigned.
Radio issues. In a particular embodiment, the mobile network (e.g., RAN nodes 210 and/or 215) monitors, for example, radio issues. For example, the mobile network may monitor channel-state reports from the main UE 202 to check whether the channel state measurements are below a certain threshold, in a particular embodiment. Additionally or alternatively, in a particular embodiment, the network monitors, for example, whether the main UE 202 is currently performing a handover. As still another alternative, the network may monitor, for example, the number of occurrences of radio link failure.
QoS unfulfillment. In a particular embodiment, the mobile network monitors, for example, whether the main UE 202 is fulfilling its QoS targets (bitrate targets, latency targets, etc.).

If the mobile network determines that conditions for enabling data transfer from backup UE 205 have been fulfilled, the network determines whether and which backup UE 205 is best suited to be enabled (if multiple UEs are listed as possible backup UEs 205). This may require that a probing/test phase is executed before enabling data transfer from a particular backup UE 205 (triggering of such probing can be based on the main UE's monitored performance, same approach can be applied when switching back to the main UE 202).

Once the backup UE 205 for which data transfer should be enabled is selected, the mobile network configures the backup mode status of the target backup UE 205 as inactive, at step 240. Thereafter, the backup UE 205 sets the backup mode status at inactive at step 245.

In a particular embodiment, this configuration is explicitly indicated such as, for example, by NAS or AS, via RRC signalling setting the backup mode status to inactive. This configuration could also happen implicitly, in a particular embodiment. For example, the backup UE 205 may receive e.g. a grant from the base station or a message on PDCCH addressed to itself, and the reception of such grant or message triggers the switching of the backup status mode to inactive. The base station can provide a grant to a backup UE 205 based on the need for resources by the main UE 202, i.e. without explicit request for resources by backup UE 205. In this way, the backup UE 205 starts transferring its data.

If the enabling of data transfer from the backup UE 205 has failed (e.g., probing/test phase showed that none of the possible backup UEs can satisfy the conditions for data transfer), the mobile network could inform the application layer that the enabling of data transfer from the backup UE 205 has failed. It could be, for instance, that such information (originated e.g. from a gNB or AMF) has reached a PCF, and it is then exposed to an AF 220 via a NEF 215.

At step 250, the backup UE 205 is transmitting data. Thus, the status of the backup UE 205 is set to inactive. However, the main UE 202 may become available again for data transmission. To enable the main UE 202 to transmit data again, the mobile network monitors, at step 255, to determine whether the data transmission from backup UE 205 should be stopped. Several options are possible depending on the type of backup the application has requested (the “Filters” field in the application request), and/or depending on network implementation and policies. As used herein, the term monitoring refers to both monitoring of actual conditions and to analytics/predictions (e.g., prediction that main UE 202 will not be able to send data). Examples are (but are not limited to):
Data failed to be transmitted. In a particular embodiment, the mobile network monitors, for example, whether main UE 202 has started to successfully transfer data.
Radio issues. In a particular embodiment, the mobile network monitors, for example, channel-state reports from the main UE 202 to check whether they are above a certain threshold. Additionally or alternatively, the mobile network may monitor whether the main UE 202 has successfully concluded a handover. As still another option, the mobile network may monitor, for example, whether the main UE 202 is not reachable.
QoS unfulfillment. In a particular embodiment, the mobile network monitors, for example, whether the main UE 202 is fulfilling again its QoS targets (bitrate targets, latency targets, etc.).

If the mobile network determines that the main UE 202 has no issues and that data transfer from backup UE 205 should be disabled, the mobile network configures the backup mode status of the backup UE 205 as active, at step 260. In a particular embodiment, the configuration may be by Non-Access Stratum or Access Stratum, such as, for example, via RRC signalling.

At step 265, the backup UE 205 sets the backup mode status to inactive. In this way, the backup UE 205 starts working in backup mode again. Thereafter, the main UE 202 begins transferring data to the AF 220 and/or, at step 270.

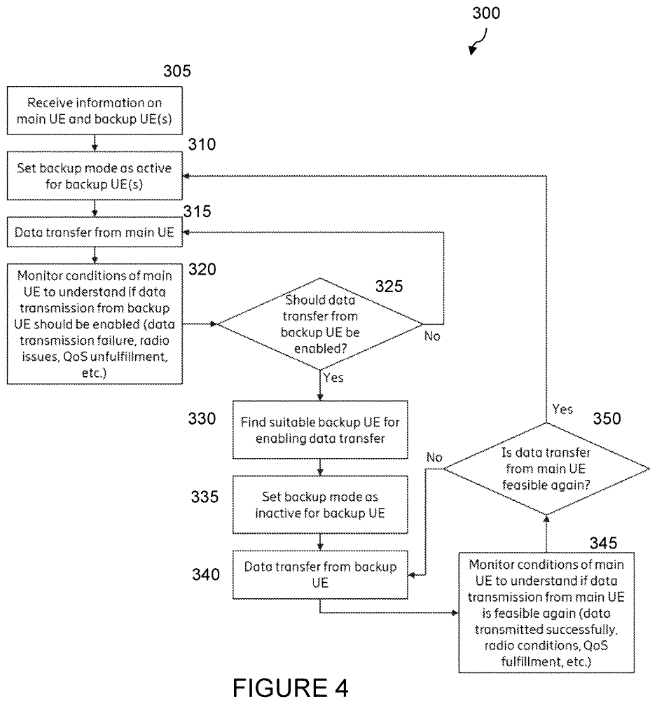

FIG. 4 illustrates a flowchart 300 of network side operations for the activation and/or deactivation of backup mode status, according to certain embodiments. According to certain embodiments, some or all of the steps illustrated in FIG. 4 may be performed by a network node such as a gNB, for example.

The method begins at step 305, when the network node receives information with respect to the main UE and one or more backup UEs. At step 310, the network node sets the backup status mode of the backup UEs as active. Thereafter, data transfer is from the main UE, at step 315.

At step 320, the network node monitors conditions of the main UE to understand/determine if data transmissions from the backup UE should be enabled at step 325. For example, the network node may determine that the main UE is subject to data transmission failure, radio issues, QoS unfulfillment or that the main UE has other issues. If so, the network node finds a suitable backup UE for enabling data transfer at step 330.

At step 335, the network node sets backup mode of the backup UE as inactive. Thereafter, data transfer is from the backup UE, at step 340.

At step 345, the network node monitors conditions of the main UE to understand/determine if data transmissions from the main UE is feasible again, at step 350. For example, the network node may determine that the main UE has successfully transmitted data, that there are no radio issues, that QOS is fulfilled, and/or that the main UE has no other issues. If so, the method returns to step 310 and the backup ode of the backup UE(s) is set to active.

### Operations of a Backup UE

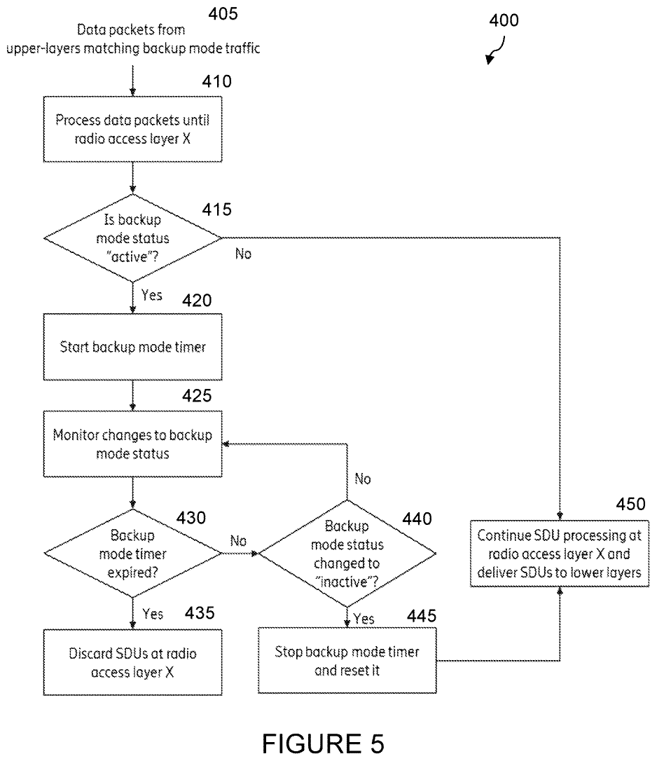

FIG. 5 illustrates an example flow diagram 400 representing the operations of a UE in backup mode, according to certain embodiments. Though certain embodiments are described herein as applying the backup mode by the PDCP layer, it is recognized that other layers of the radio stack may perform some or all of these depicted steps.

The method begins at step 405 when the radio stack of the UE receives packets from upper-layers (e.g., IP). For example, in a particular embodiment, the SDAP may receive data packets from upper-layers. The SDAP may then associate the data packets with the relevant 5QI and/or bearer and provide them to PDCP.

At step 410, the PDCP or another layer of the UE processes the data packets. As described above, different types of processing at PDCP could be considered for packets related to backup mode operation. For example, in a particular embodiment, processing may simply involve checking whether backup mode operation applies to certain 5QIs and/or radio bearers and putting packets associated to these into a backup mode buffer without any further processing (e.g., processing such as encryption could be applied by PDCP only if backup mode is disabled). Additionally or alternatively, processing may include performing other operations of PDCP such as, for example, packet encryption, and then putting the data packets into the backup mode buffer.

If the backup mode is configured without any traffic filter, all received packets at PDCP follow these operations. If traffic filters are configured, the UE checks, by the PDCP layer, whether the specific traffic (5QI, bearer, etc.) should be associated to the backup mode operation. In case it shouldn't, the UE proceeds with the normal operations and with the subsequent submission of the data to lower layers (RLC/MAC).

For the SDUs associated to backup mode, the PDCP layer of the UE checks the status of the backup mode at step 415 to determine if the backup status mode is set to active. If the status is set as inactive, the UE proceeds with the normal operations submitting the data to lower layers (RLC/MAC), at step 450. Conversely, if the UE determines at step 415 that the backup mode status is set to active, the UE starts the backup mode timer at step 420 and starts monitoring changes to the backup mode status at step 425.

If, at step 430, the UE determines that the backup mode timer is not expired and that, at step 440, that the backup mode status is changed by the network while the timer is running (i.e., the network changes the status to inactive), the method proceeds to step 445 where the UE stops and resets the backup mode timer. The UE then proceeds, at step 450, with the normal operations at PDCP and finally with submitting the data to lower layers (RLC/MAC). If relevant, the UE also restores the configuration of the RAN stack which were previously changed due to backup mode being active. The UE could inform the application layer that the backup mode has been inactivated.

However, if the backup mode timer expires at step 430, and the status has remained to active, the UE discards the SDUs, at step 435.

As said above, it could be that backup mode status is exposed from the UE to the application layer at device side, in a particular embodiment. For example, the UE could inform the application layer whether the backup mode status is set to active/inactive, so that the application layer could configure itself accordingly. For example, the application could decide to pause itself or set itself to a low-profile operating setting when the backup mode is active and resume its normal operations or set itself to a normal/high-profile operating setting when the backup mode is inactive. For example, if the target device is a camera, when backup mode is active the camera could work with a low video resolution and switch to a higher video resolution when the backup mode is inactivated. In this way, even if not video is not transmitted as data transfer is not enabled, video is generated and be ready to be transmitted as soon as the backup mode is inactivated, the consumer of the video will receive a low-quality video (which is anyway better than no video at all) and subsequently the target device could switch to a better video resolution so that the consumer of the video will receive a better quality. This could allow a low processing load (and consequently energy consumption) when backup mode is active without strongly affecting the time for having video ready to be sent when the backup mode is inactivated. As another example, if the target device is a sensor monitoring a certain parameter, when the backup mode is active, the sensor could work with a lower monitoring frequency (e.g., every 30s). Conversely, when the backup mode is inactivated, the sensor could work with a higher monitoring frequency (e.g., every 5s).

If new data arrives while the backup mode timer is running, several options apply. It could be that data are split into blocks where each block has associated independent timers, in a particular embodiment. Alternatively, the timer may be kept running and all buffered SDUs may be discarded (also new ones arrived after the time has been started) when the timer expires.

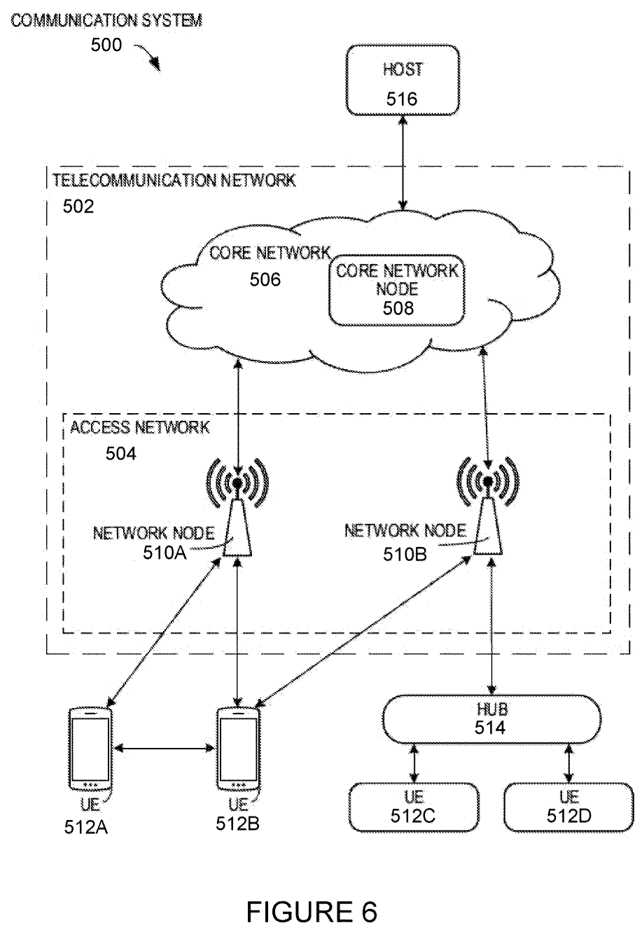

FIG. 6 shows an example of a communication system 500 in accordance with some embodiments. In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

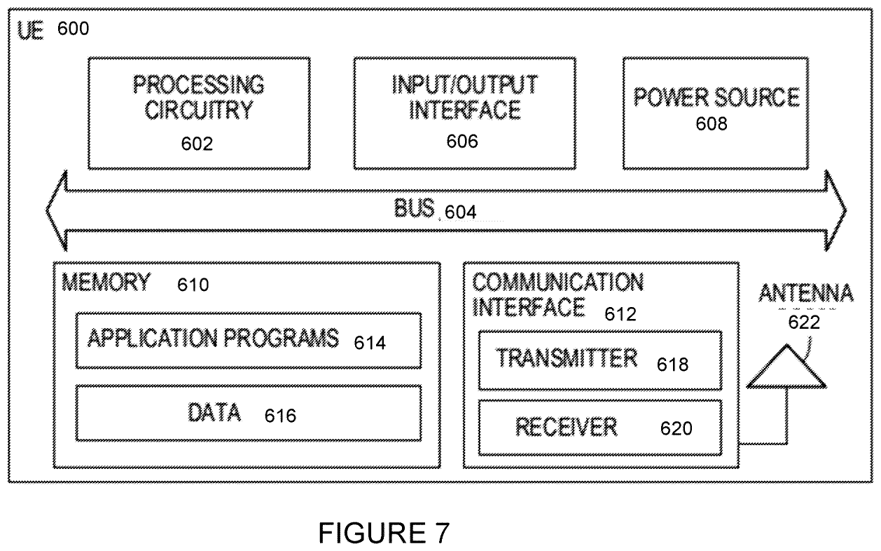

FIG. 7 shows a UE 600 in accordance with some embodiments.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

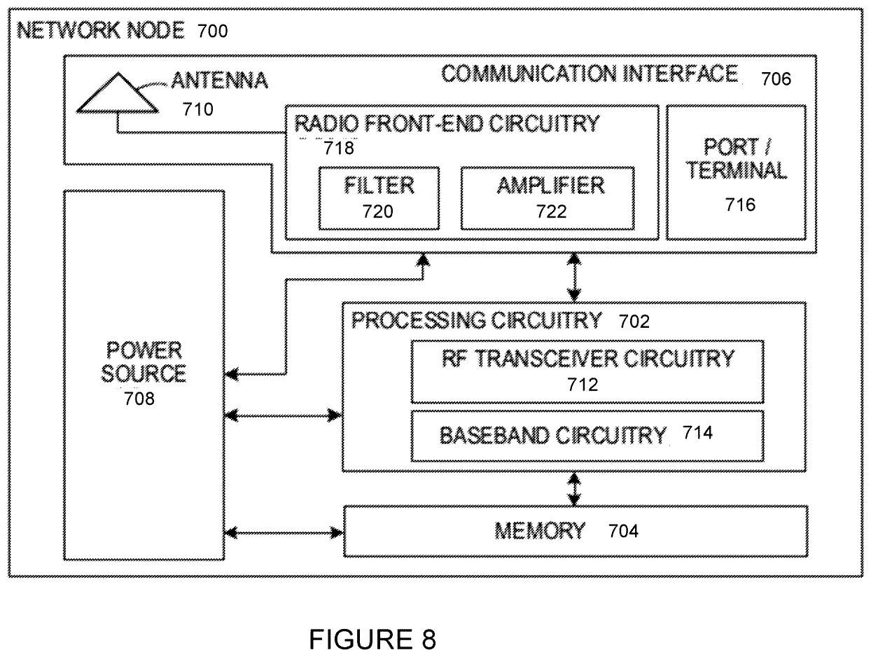

FIG. 8 shows a network node 700 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 8 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

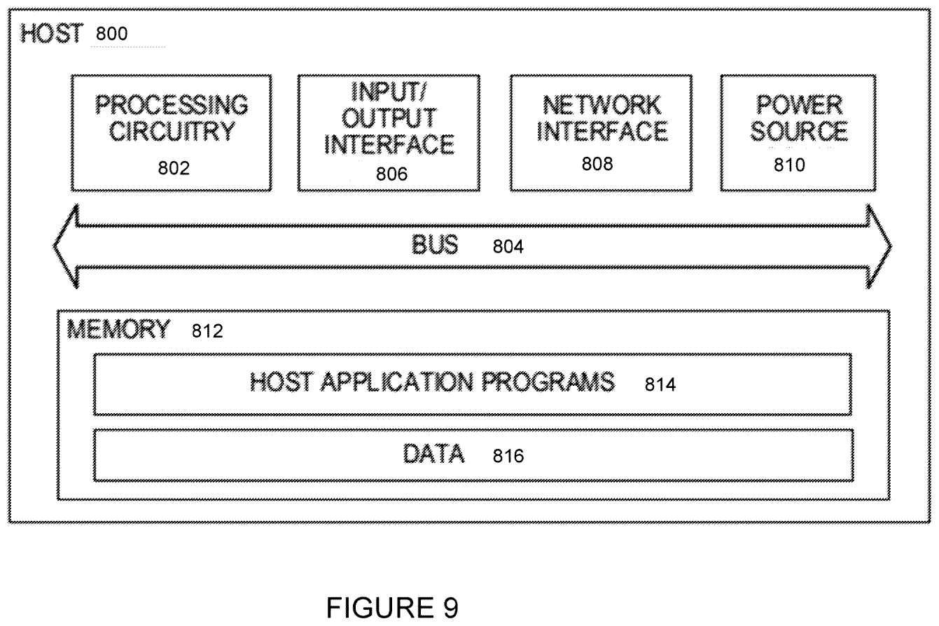

FIG. 9 is a block diagram of a host 800, which may be an embodiment of the host 516 of FIG. 6, in accordance with various aspects described herein.

As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

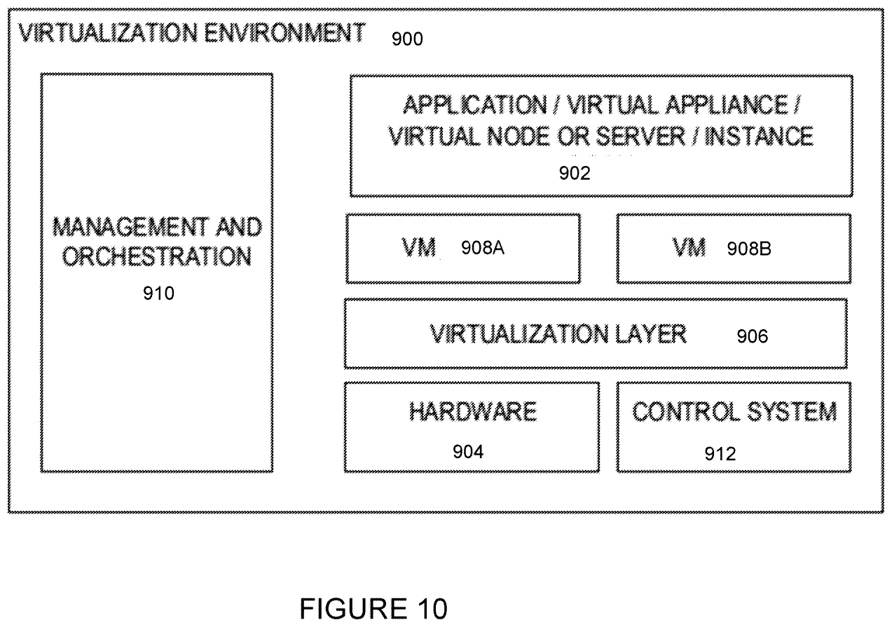

FIG. 10 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

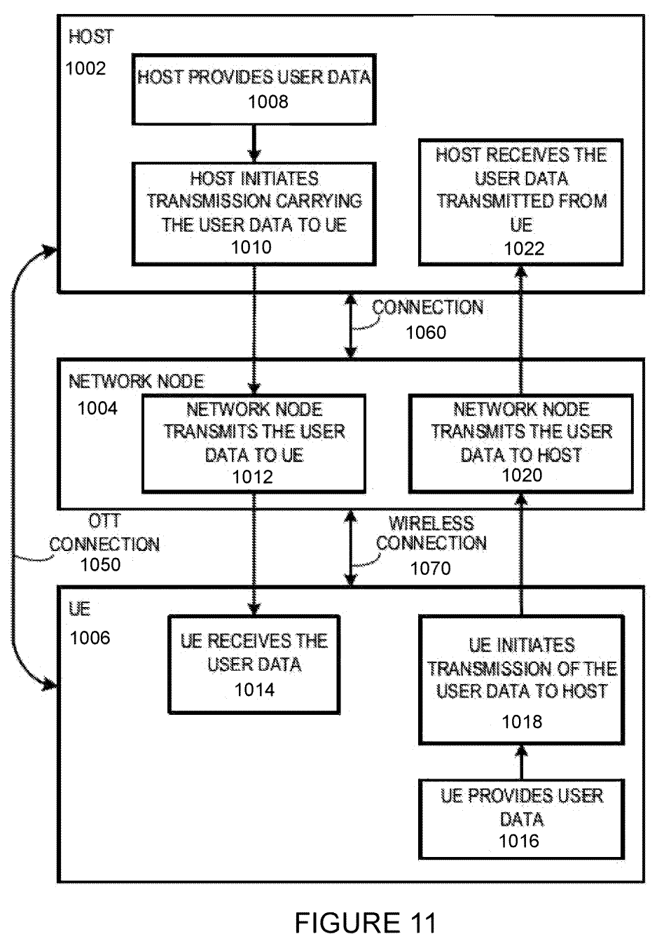

FIG. 11 shows a communication diagram of a host 1002 communicating via a network node 1004 with a UE 1006 over a partially wireless connection in accordance with some embodiments.

Example implementations, in accordance with various embodiments, of the UE (such as a UE 512a of FIG. 6 and/or UE 600 of FIG. 7), network node (such as network node 510a of FIG. 6 and/or network node 700 of FIG. 8), and host (such as host 516 of FIG. 6 and/or host 800 of FIG. 9) discussed in the preceding paragraphs will now be described with reference to FIG. 11.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 6) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc. ; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

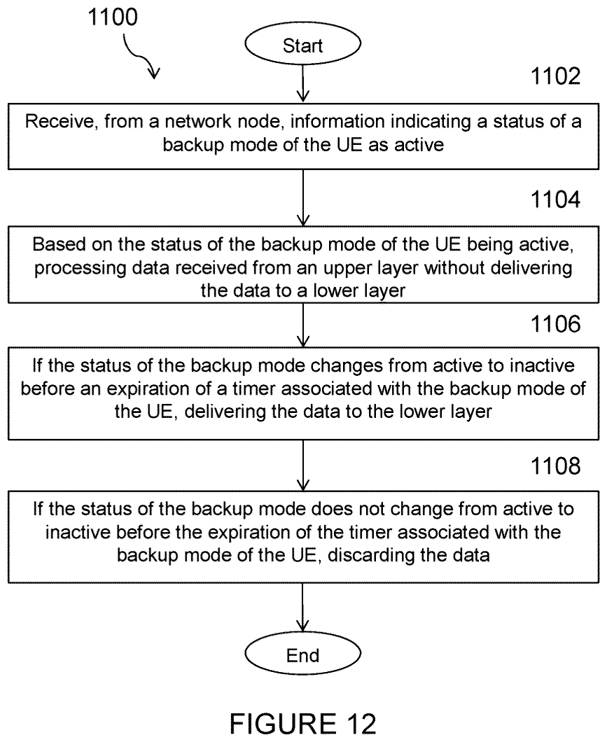

FIG. 12 illustrates a method 1100 by UE 105, 205 operating as a backup UE for at least one main UE for data communication, according to certain embodiments. The method begins at step 1102 when the UE 105, 205 receives, from a network node 110, 210, information indicating a status of a backup mode of the UE as active. Based on the status of the backup mode of the UE being active, the UE 105, 205 processes data received from an upper layer without delivering the data to a lower layer, at step 1104. If the status of the backup mode changes from active to inactive before an expiration of a timer associated with the backup mode of the UE 105, 205, the UE 105, 205 delivers the data to the lower layer at step 1106. Conversely, if the status of the backup mode does not change from active to inactive before the expiration of the timer associated with the backup mode of the UE 105, 205, the UE 105, 205 discards the data.

In a particular embodiment, processing the data without delivering the data to the lower layer comprises storing the data in a buffer.

In a particular embodiment, the information indicates at least one of: a type of data traffic to which the backup status of active applies; an indication of at least one DRB to which the backup status of active applies; an indication of at least one 5QI to which the backup status of active applies; and a configuration of RAN stack to which the backup status of active applies.

In a particular embodiment, the UE receives the data from the upper layer and processing the data includes determining, based on a type of the data, that the status of active applies to the data and storing the data in a buffer without delivering the data to the lower layer.

In a particular embodiment, the UE receives the data from the upper layer, and processing the data includes: determining a DRB or 5QI associated with the data; based on the DRB or 5QI associated with the data, determining that the status of active applies to the data; and storing the data in a buffer without delivering the data to the lower layer.

In a further particular embodiment, processing the data further includes encrypting the data for the DRB.

In a particular embodiment, the UE receives additional data from the upper layer. The UE determines, based on the information, that the status of active does not apply to the additional data, and the UE delivers the additional data to the lower layer.

In a particular embodiment, the upper layer comprises an IP layer or an Institute of Electrical and Electronics Engineers Medium Access Control (IEEE MAC) layer.

In a particular embodiment, while the backup mode of the UE is active, the data is processed by a layer of the UE that comprises a SDAP or PDCP layer.

In a particular embodiment, the lower layer comprises a RLC layer or a MAC layer.

In a particular embodiment, in response to receiving the data from the upper layer, the UE initiates the timer associated with the backup mode of the UE and monitors the timer to determine the expiration of the timer.

In a particular embodiment, when the status of the backup mode does not change from active to inactive before the expiration of the timer, the UE removes the data from the buffer of the UE.

In a particular embodiment, before the expiration of the timer, the UE receives an indication to change the status of the backup mode from active to inactive. The data is delivered to the lower layer in response to the indication to change the status of the backup mode from active to inactive.

In a particular embodiment, the indication comprises at least one of: an identifier associated with the UE operating as the backup UE; and an indication of a particular type of traffic to which the backup status of inactive applies.

In a particular embodiment, the UE transmits, to an application at the UE, a status indication indicating that the UE has set the status of the backup mode as active.

In a particular embodiment, the UE transmits, to the network node, a response message indicating an acceptance by the UE of the backup status of active.

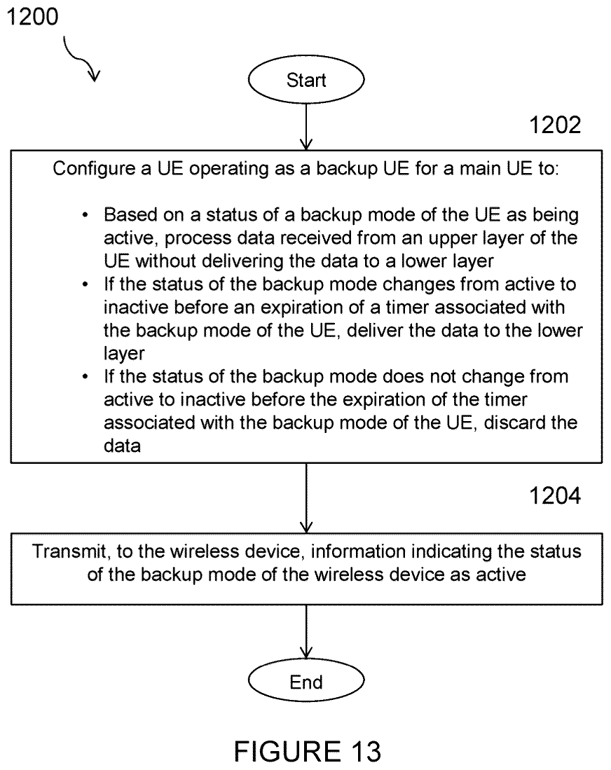

FIG. 13 illustrates a method 1200 by a network node 110, 220, according to certain embodiments. The method begins at step 1202 when the network node 110, 220 configures a UE operating as a backup UE 105, 205 for a main UE 102. Specifically, according to certain embodiments, the UE 105, 205 is configured to, based on a status of a backup mode of the UE as being active, process data received from an upper layer of the UE 105, 205 without delivering the data to a lower layer. If the status of the backup mode changes from active to inactive before an expiration of a timer associated with the backup mode of the UE 105, 205, the UE 105, 205 is configured to deliver the data to the lower layer. However, if the status of the backup mode does not change from active to inactive before the expiration of the timer associated with the backup mode of the UE 105, 205, the UE 105, 205 is configured to discard the data. At step 1204, the network node 110, 210 transmits, to the UE 105, 205, information indicating the status of the backup mode of the UE 10, 205 as active.

In a particular embodiment, the network node 110, 210 receives, from an AF or an AS 120, 220 an indication that: the UE is operating as the backup UE 105, 205 for the main UE 101, and another UE is operating as the main UE 101. The network node 110, 210 transmits, to the UE, information indicating that the UE is the backup UE 105, 205. The network node 110, 210 transmits, to the other UE, information indicating that the other UE is the main UE 101.

In a particular embodiment, the network node 110, 210 receives, from the AF or the AS 120, 220, a first indication of a type of data to which the status of the backup mode of active applies. The network node 110, 210 transmits, to the UE 105, 205, a second indication of the type of data to which the status of the backup mode as active applies.

In a particular embodiment, the first indication of the type of data to which the status of backup mode of active applies comprises at least one of a 5-tuple; a DNN; and appID. The second indication of the type of data to which the status of backup mode of active applies comprises at least one of a 5QI, DRB, 5-tuple, a DNN, and an appID.

In a particular embodiment, the network node determines that the main UE is capable of transmitting data. The network node determines the status of the backup mode of the UE to be active based on the main UE being capable of transmitting data.

In a particular embodiment, when determining that the main UE is capable of transmitting the data, the network node performs at least one of: determining that a communication was received from the main UE; determining that a communication was received from the main UE during a time period that is less than a threshold; determining that a communication received from the main UE has a channel quality above a minimum channel quality threshold; and determining that a communication received from the main UE has a QoS above a minimum QoS threshold.

In a particular embodiment, after transmitting information to the UE indicating the status of the backup mode of the UE is active, the network node determines that the main UE is not capable of transmitting data and transmits, to the UE operating as the backup UE, information indicating the status of the backup mode of the UE as inactive based on the main UE not being capable of transmitting data.

In a particular embodiment, when determining that the main UE is not capable of transmitting data, the network node performs at least one of: determining that a communication from the main UE is not being received by the network node; determining that a communication from the main UE has not been received by the network node during a time period that is greater than a threshold; determining that a channel quality associated with a transmission by the main UE is below a minimum channel quality threshold; and determining that a quality of service, QoS, associated with the main UE is below a minimum QoS threshold.

In a particular embodiment, the network node receives, from an AF or AS, the at least one condition to be monitored for determining the backup status of the UE.

In a particular embodiment, a plurality of UEs are operating as backup UEs for the main wireless device, and the network node selects the UE from the plurality of UEs to operates as the backup UE for the main UE.

In a particular embodiment, the network node transmits to the main UE an indication that the backup mode status of the UE is set to active.

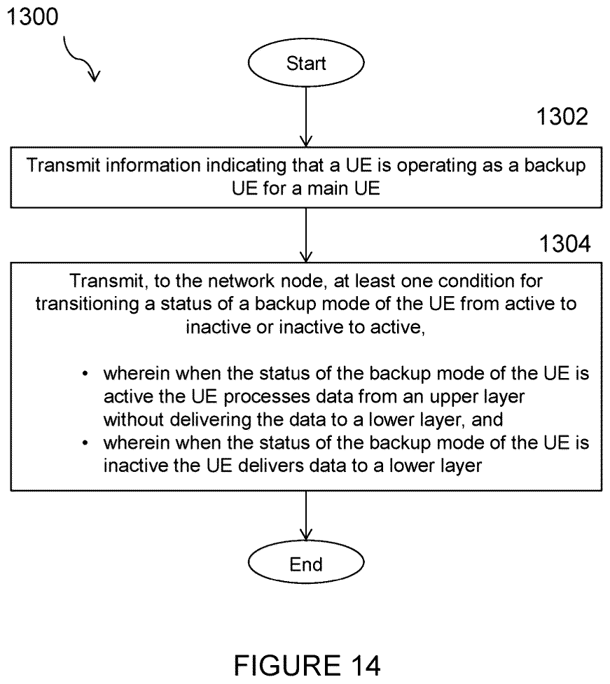

FIG. 14 illustrates a method 1300 by an AF or AS 120, 220, according to certain embodiments. The method begins at step 1302 when the AF or AS 120, 220 transmits information indicating that a UE is operating as a backup UE 105, 205 for a main UE 101. At step 1304, the AF or AS 120, 220 transmits, to the network node, at least one condition for transitioning a status of a backup mode of the UE 105, 205 from active to inactive or inactive to active. When the status of the backup mode of the UE 105, 205 is active, the UE 105, 205 processes data from an upper layer without delivering the data to a lower layer. However, when the status of the backup mode of the UE 105, 205 is inactive, the UE 105, 205 delivers the data to the lower layer.

In a particular embodiment, the AF or AS 120, 220 transmits an indication of a type of data traffic to which the backup status of inactive applies.

In a particular embodiment, the indication of the type of data traffic to which the backup status of inactive applies comprises at least one of a 5-tuple; a DNN; and an appID.

In a particular embodiment, the at least one condition is associated with a capability of the main UE 101 to transmit the data.

In a particular embodiment, the at least one condition for transitioning the status of the backup mode of the UE comprises at least one of: whether a communication associated with the main UE is received by a network node; whether a communication from the main UE is received by the network node during a time period that is greater than a threshold; whether a channel quality associated with a communication associated with the main UE is below a minimum channel quality threshold; and whether a QoS associated with the main UE is below a minimum QoS threshold.

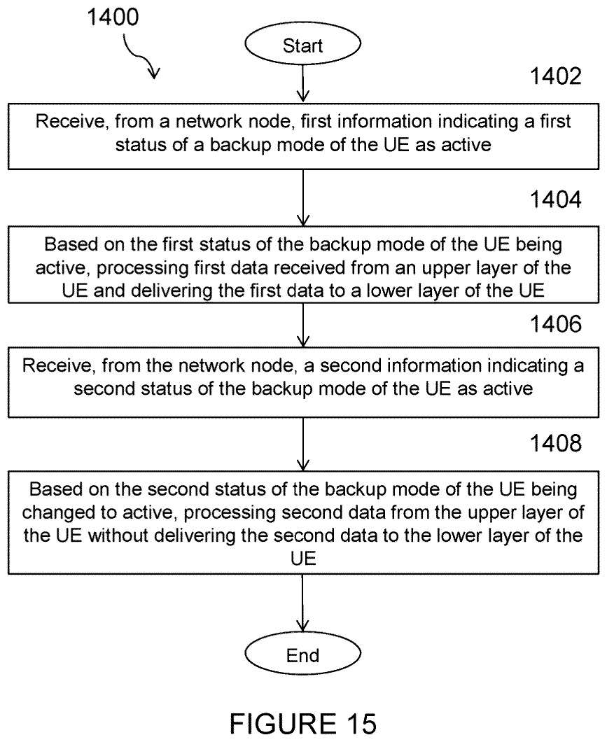

FIG. 15 illustrates method 1400 by a UE operating as a main UE 101 for data communication, according to certain embodiments. The method begins at step 1402 when the main UE 101 receives, from a network node, a first information indicating a first status of a backup mode of the UE as inactive. Based on the first status of the backup mode of the UE 101 being inactive, the main UE 101 processes first data received from an upper layer of the UE and delivers the first data to a lower layer of the UE, at step 1404. At step 1406, the UE operating as the main UE 101 receives, from the network node, a second information indicating a second status of the backup mode of the UE as active. Based on the second status of the backup mode of the UE being changed to active, the UE operating as the main UE 101 processes the second data from the upper layer of the UE without delivering the second data to the lower layer of the UE.

In a particular embodiment, processing the second data without delivering the second data to the lower layer comprises storing the second data in a buffer.

In a particular embodiment, the second information indicates at least one of: a type of data traffic to which the backup status of active applies; an indication of at least one DRB to which the backup status of active applies; an indication of at least one 5QI to which the backup status of active applies; and a configuration of a RAN stack to which the backup status of active applies.

In a particular embodiment, the upper layer comprises an IP layer or an IEEE MAC layer. In a particular embodiment, the first data and/or second data is processed by a layer of the UE that comprises a SDAP or PDCP layer.

In a particular embodiment, the lower layer comprises a RLC layer or a MAC layer.

In a particular embodiment, in response to receiving the second data from the upper layer, the main UE 101 initiates the timer associated with the backup mode of the UE and monitors the timer to determine the expiration of the timer.

In a particular embodiment, when the status of the backup mode does not change from active to inactive before the expiration of the timer, the main UE 101 removes the second data from a buffer of the UE.

In a particular embodiment, before the expiration of the timer, the main UE 101 receives third information indicating to change the status of the backup mode from active to inactive, and the second data is delivered to the lower layer in response to the third information indicating to change the status of the backup mode from active to inactive.

1. A method by a User Equipment, UE; (operating as a backup UE for at least one main UE for data communication, the method comprising:
receiving, from a network node, information indicating a status of a backup mode of the UE as active;
based on the status of the backup mode of the UE being active, processing data received from an upper layer without delivering the data to a lower layer;
if the status of the backup mode changes from active to inactive before an expiration of a timer associated with the backup mode of the UE, delivering the data to the lower layer; and
if the status of the backup mode does not change from active to inactive before the expiration of the timer associated with the backup mode of the UE, discarding the data upon expiration of the timer.

2. The method of claim 1, wherein processing the data without delivering the data to the lower layer comprises storing the data in a buffer.

3. The method of claim 1, wherein the information indicates at least one of:
a type of data traffic to which the backup status of active applies;
an indication of at least one Data Radio Bearer (DRB) to which the backup status of active applies;
an indication of at least one 5QI to which the backup status of active applies; and
a configuration of a Radio Access Network, (RAN) stack to which the backup status of active applies.

4. The method of claim 3, further comprising:
receiving the data from the upper layer, and
wherein processing the data received from the upper layer when the status of the backup mode of the UE does not change from active to inactive before the expiration of the time comprises:
determining, based on a type of the data, that the status of active applies to the data; and
storing the data in a buffer without delivering the data to the lower layer.

5. The method of claim 3, further comprising:
receiving the data from the upper layer, and
wherein processing the data received from the upper layer when the status of the backup mode of the UE does not change from active to inactive before the expiration of the time comprises:
determining a DRB or 5QI associated with the data;
based on the DRB or 5QI associated with the data, determining that the status of active applies to the data;
storing the data in a buffer without delivering the data to the lower layer.

6. The method of claim 5, wherein processing the data further comprises encrypting the data for the DRB.

7. The method of claim 3, further comprising:
receiving additional data from the upper layer;
determining, based on the information, that the status of active does not apply to the additional data; and
delivering the additional data to the lower layer.

8. The method of claim 1, wherein the upper layer comprises an Internet Protocol (IP) layer or an Institute of Electrical and Electronics Engineers (IEEE) Medium Access Control (MAC) layer; and wherein the lower layer comprises a Radio Link Control (RLC) laver or a Medium Access Control (MAC) layer.

9. The method of claim 1, wherein, while the backup mode of the UE is active, the data is processed by a layer of the UE that comprises a Service Data Adaption Protocol SPAP (SDAP) or Packet Data Convergence Protocol; (PDCP) layer.

10. (canceled)

11. The method of claim 1, further comprising:
in response to receiving the data from the upper layer, initiating the timer associated with the backup mode of the UE; and
monitoring the timer to determine the expiration of the timer.

12. The method of claim 1, wherein, when the status of the backup mode does not change from active to inactive before the expiration of the timer, discarding the data upon expiration of the timer comprises removing the data from the buffer of the UE.

13. The method of claim 1, further comprising:
before the expiration of the timer, receiving an indication to change the status of the backup mode from active to inactive, and
wherein the data is delivered to the lower layer in response to the indication to change the status of the backup mode from active to inactive.

14. The method of claim 13, wherein the indication comprises at least one of:
an identifier associated with the UE operating as the backup UE; and
an indication of a particular type of traffic to which the backup status of inactive applies.

15. The method of claim 1, further comprising at least one of:
transmitting, to an application at the UE, a status indication indicating that the UE has set the status of the backup mode as active and
transmitting, to the network node, a response message indicating an acceptance by the UE of the backup status of active.

16-32. (canceled)

33. A method by a User Equipment (UE) operating as a main UE for data communication, the method comprising:
receiving, from a network node, a first information indicating a first status of a backup mode of the UE as inactive,
based on the first status of the backup mode of the UE being inactive, processing first data received from an upper layer of the UE and delivering the first data to a lower layer of the UE;
receiving, from the network node, a second information indicating a second status of the backup mode of the UE as active, and
based on the second status of the backup mode of the UE being changed to active, processing second data from the upper layer of the UE without delivering the second data to the lower layer of the UE.

34. The method of claim 33, wherein processing the second data without delivering the second data to the lower layer comprises storing the second data in a buffer.

35. The method of claim 33, wherein the second information indicates at least one of:
a type of data traffic to which the backup status of active applies;
an indication of at least one Data Radio Bearer (DRB) to which the backup status of active applies;
an indication of at least one 5QI to which the backup status of active applies; and
a configuration of a Radio Access Network (RAN) stack to which the backup status of active applies.

36. The method of claim 33, wherein the upper layer comprises an Internet Protocol (IP) layer or an Institute of Electrical and Electronics Engineers (IEEE) Medium Access Control (MAC) layer; and wherein the lower layer comprises a Radio Link Control (RLC) layer or a Medium Access Control (MAC) layer.

37. The method of claim 33, wherein the first data and/or second data is processed by a layer of the UE that comprises a Service Data Adaption Protocol (SDAP) or Packet Data Convergence Protocol (PDCP) layer.

38. (canceled)

39. The method of claim 33, further comprising:
in response to receiving the second data from the upper layer, initiating the timer associated with the backup mode of the UE; and
monitoring the timer to determine the expiration of the timer.

40. The method of claim 39, further comprising: when the status of the backup mode does not change from active to inactive before the expiration of the timer, removing the second data from a buffer of the UE.

41. The method of claim 40, further comprising:
before the expiration of the timer, receiving third information indicating to change the status of the backup mode from active to inactive, and
wherein the second data is delivered to the lower layer in response to the third information indicating to change the status of the backup mode from active to inactive.

42. A User Equipment (UE) operating as a backup UE for at least one main UE for data communication, the UE adapted to:
receive, from a network node, information indicating a status of a backup mode of the UE as active;
based on the status of the backup mode of the UE being active, process data received from an upper layer without delivering the data to a lower layer;
if the status of the backup mode changes from active to inactive before an expiration of a timer associated with the backup mode of the UE, deliver the data to the lower layer;
if the status of the backup mode does not change from active to inactive before the expiration of the timer associated with the backup mode of the UE, discard the data upon expiration of the timer.

43-47. (canceled)

48. A User Equipment (UE) operating as a main UE for data communication, the UE adapted to:
receive, from a network node, a first information indicating a first status of a backup mode of the UE as inactive,
based on the first status of the backup mode of the UE being inactive, process first data received from an upper layer of the UE and delivering the first data to a lower layer of the UE;
receive, from the network node, a second information indicating a second status of the backup mode of the UE as active, and
based on the second status of the backup mode of the UE being changed to active, process second data from the upper layer of the UE without delivering the second data to the lower layer of the UE.

49. (canceled)

50. The method of claim 1, comprising:
enabling tuning of how long the data is kept by the backup UE before the data is discarded thereby allowing provision of different levels of service robustness and information loss.
